(19) United States
(12) Patent Application Publication
(10) Pub. No.: US 2004/0103375 A1
(43) Pub. Date: May 27, 2004

(54) Method and apparatus for automated schematic rendering

(76) Inventors: Rutie Chen, Madison Heights, MI (US); John F. Terris, Saline, MI (US); Gregory S. Stoll, Lake Forest, CA (US); Paul Simms, Lake Forest, CA (US)

Correspondence Address: BAKER & HOSTETLER LLP, Washington Square, Suite 1100, 1050 Connecticut Avenue, N.W., Washington, DC, 20036, US

(21) Appl. No.: 10/305,014

(22) Filed: Nov. 27, 2002

(51) Int. Cl. G06F 15/00

(52) U.S. Cl. 715/517

(57) ABSTRACT

A method for creating a layout includes the steps of retrieving selected object data, displaying related object data associated with the selected object data, and linking selected related object data to the selected object data to create a layout. Diagrams of engines showing interconnections and layouts of the engines are thus quickly and efficiently generated. Simulations of the layouts are also provided for diagnosis of engine problems.

### FIELD OF THE INVENTION

The present invention relates generally to schematic designs. More particularly, the present invention relates to creating and using schematic designs.

### BACKGROUND OF THE INVENTION

A vital component for diagnosing and fixing a problem with an engine is to understand how the engine is laid out and how the parts are interconnected. This requires people with expert knowledge in these fields to get together and collaborate in making these manuals. Each component of the engine will have to be drawn and described as well as be interconnected with other components. This process is very time consuming and costly.

Once the manuals have been written, reviewed and edited, the manuals are distributed. Currently the manuals that are offered have diagrams showing engine layouts. The manuals also break out certain components to show interconnections. Some problems with using these manuals is their overall size. Each manual for an engine is usually thick and bulky making them hard to handle. Given that every motor vehicle does not have the same engine, anyone who needs to diagnose and fix a problem for multiple types of engines will require a large volume of these thick, bulky manuals.

### SUMMARY OF THE INVENTION

The present invention overcomes deficiencies in the prior art by providing for efficiently generating diagrams of engines showing interconnections and layouts of the engines. The present invention also provides for diagnosis of engine problems as well as simulations.

In accordance with one embodiment of the present invention, a method for creating a layout includes the steps of retrieving selected object data, displaying related object data associated with the selected object data, and linking selected related object data to the selected object data to create a layout.

In accordance with another embodiment of the present invention, a device for creating a layout includes a reader that retrieves selected object data, and a display in communication with the reader. The display displays related object data associated with the selected object data. The invention further includes a linker that links selected related object data to the selected object data to create a layout.

In an alternate embodiment of the invention, a system for creating a layout includes a means for retrieving selected object data, a means for displaying related object data associated with the selected object data, and a means for linking selected related object data to the selected object data to create a layout.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flow diagram showing method steps of the present invention.

FIG. 2 is an illustration of a screen showing the options a user has in selecting a engine platform to work from.

FIG. 3 is an illustration of a screen showing a user selecting a particular component to use.

FIG. 4 is an illustration of a screen showing a text list of a selected component and other components that can be connected to the selected component.

FIG. 5A is an illustration of a screen showing a text list of a selected component and other components that can be connected to the selected component.

FIG. 5B is an illustration of a screen showing a graphical representation of selected components and their interconnections.

FIG. 6A is an illustration of a screen showing a text list of selected components and other components that can be connected to the selected component.

FIG. 6B is an illustration of a screen showing a graphical representation of selected components and their interconnections.

FIG. 7A is an illustration of a schematic showing the rendered layout.

FIG. 7B is an illustration of a simulation of the schematic once the ignition switch is activated.

FIG. 7C is an illustration of a simulation of the schematic in a final state.

FIG. 8 is an illustration of a device of the present invention.

### DETAILED DESCRIPTION OF THE INVENTION

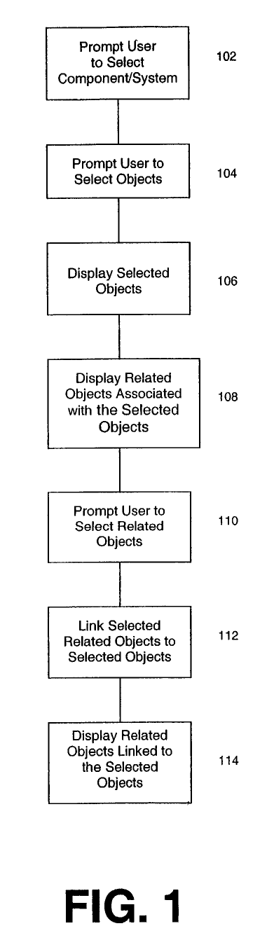

The present invention allows for automated schematic rendering. In one embodiment of the invention, as illustrated in FIG. 1, the user is prompted in step 102 to select a component or system to use. In step 104 the user is prompted to select an object that can be used in the selected component or system. Once a user has selected the object, the selected object is retrieved and displayed in step 106. In step 108, object(s) related to or associated with the selected object are also retrieved to be displayed. In step 110, a user is prompted to select a related object or objects to be connected with the selected object. Once the related object or objects are selected, in step 112, these related objects are retrieved and linked to the selected objects. In step 114, the related objects are linked to the selected objects and displayed as a group. In this embodiment of the invention, a layout for an engine can be easily produced. The invention will prompt the user to select what component or system the user wishes to work with and also objects that are to be used. Once these selections are made, the invention will indicate what other related objects can be connected to selected objects. This will cut down on errors in designing a layout and will also result in less work for the designer. Thus layout can be generated quickly and efficiently.

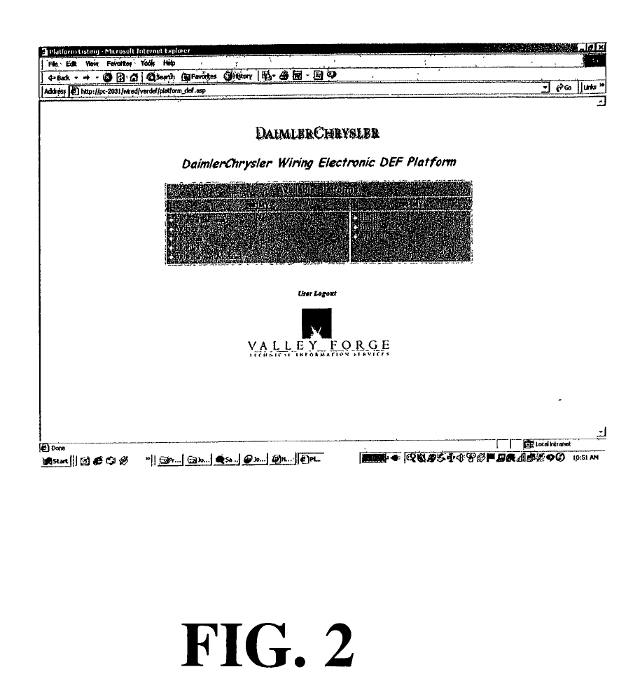

FIGS. 2-6B illustrate an embodiment of the invention using depictions of computer screens. FIG. 2 illustrates a log-in screen where the user selects the vehicle (or platform) the user wants to work in. In this case the user has selected (HBNB_March 2004). Once the user has logged-in and selected a vehicle or platform to use, the user is prompted to select a component/system to review/expand.

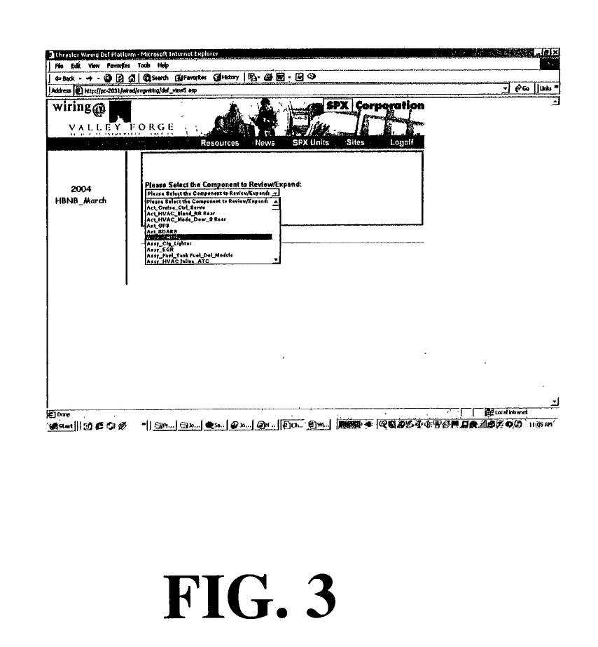

FIG. 3 shows a screen in which the user is given a plurality of choices of components/systems to review/expand. As illustrated in FIG. 3 the user has chosen “ASSY_CHMSL”. Once the user has selected the component/system, the user will be presented with objects that are related to the component/system.

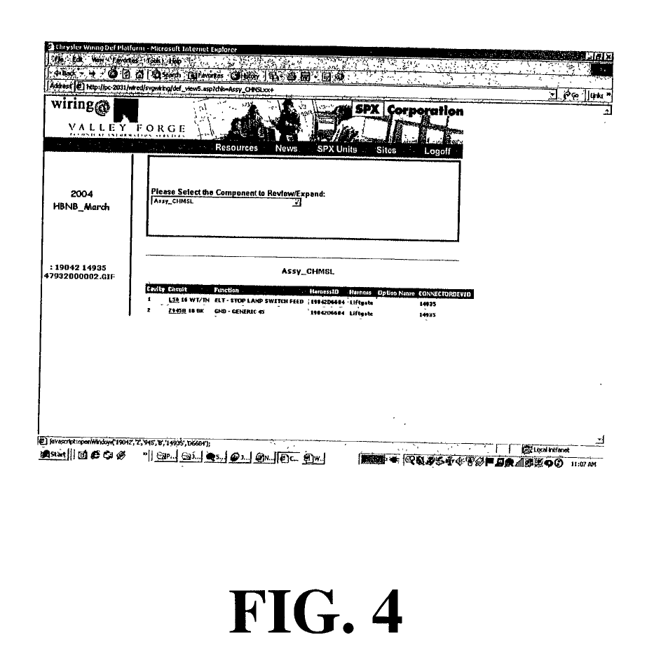

In FIG. 4 components associated with “ASSY_CHMSL” to review/expand are displayed. Under this category there are two components listed which the user may select. As illustrated in FIG. 4, the user has selected a circuit on cavity 2 which is the second displayed item. Once the user has selected an object or component, a list of other related objects or components are shown which could be connected to the selected object. In FIG. SA the first component “HARN ID: 19042 Splice_S1803 Z945 S1803” has been chosen and displayed. Below the displayed component are the choices of other related objects which could be connected to the selected object.

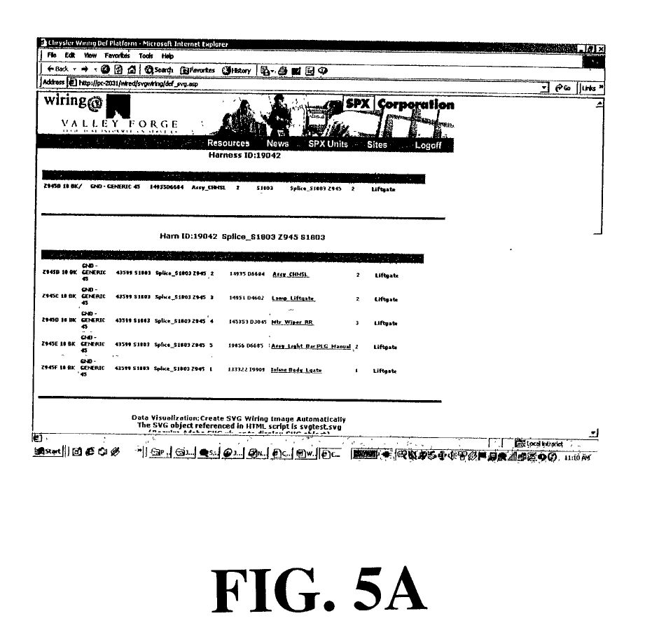

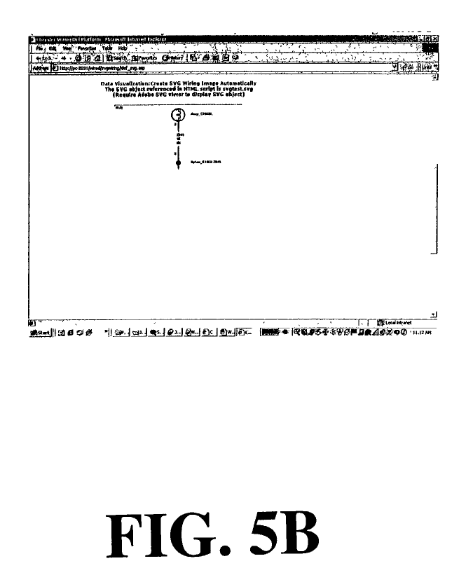

In FIG. 5B an illustration of the selected object is shown on the same screen. As can be seen in FIG. 5A from the right hand margin the screen is at the very top. As you scroll down as illustrated in FIG. 5B, it is evident that the bottom portion of the screen illustrates the selected object.

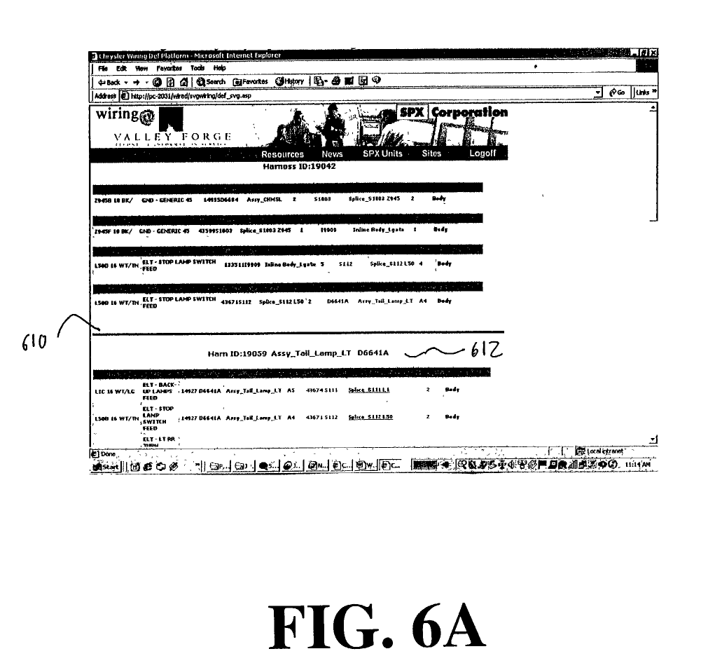

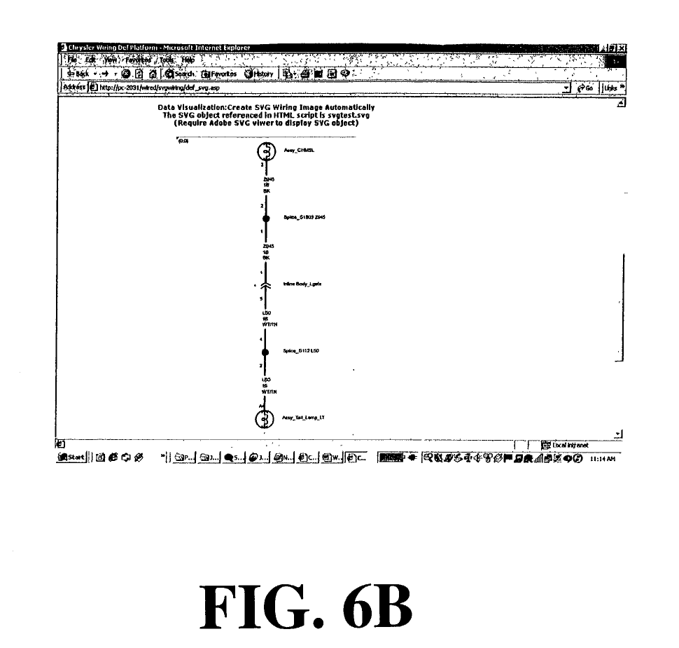

The user will then be prompted to choose a related option or component. As illustrated in FIG. 6A, each selected component is shown above middle line 610. The related objects or components will be shown below the selected object 612. In FIG. 6B the bottom portion of the screen is illustrated showing the selected objects being connected to one another and awaiting a user input to select a related object to the last selected object. Once the schematic has been rendered it can be saved for future use. In one embodiment of the invention the actual operation of the schematic can be simulated.

Once the layout has been rendered, the layout can be saved for future use. In one embodiment of the invention, the layout can be used for diagnosing a problem with the engine. For example, if there is a problem with the tail lamp, the rendered layout that was saved and illustrated in FIG. 6 can be retrieved and displayed. The layout of the tail light along with other components the tail light is connected to can then be displayed to diagnose the problem. Thus, diagnosis of a problem can be done quickly and efficiently.

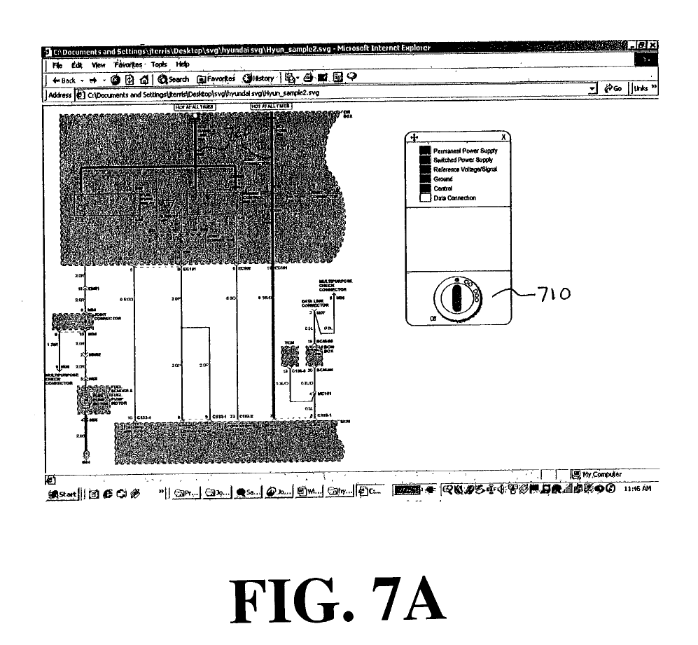

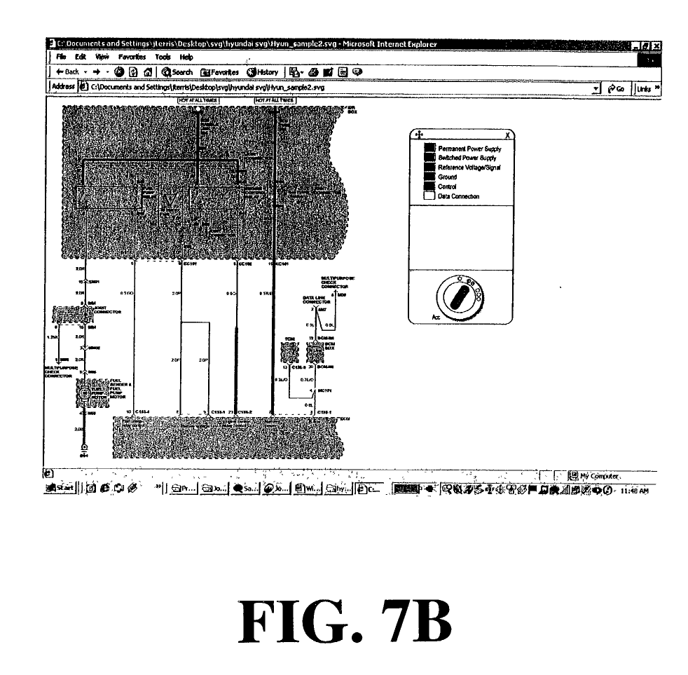

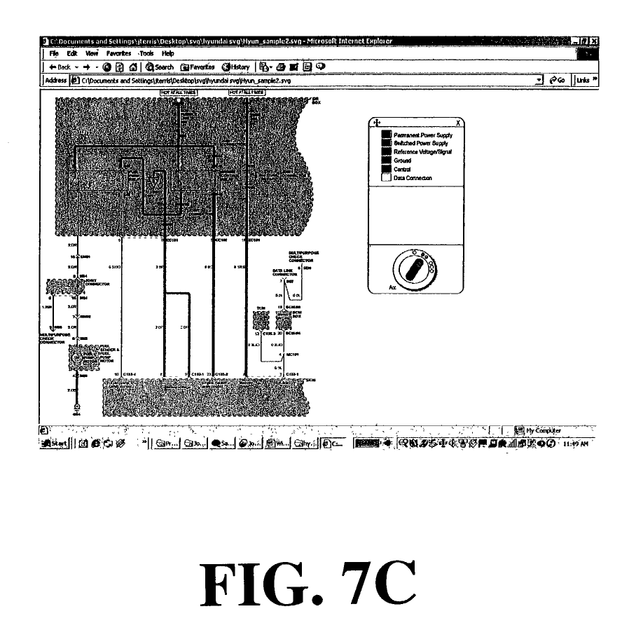

In FIG. 7A the schematic that was rendered is simulated when the ignition switch 710 is turned on using a pointer. The bold lines 720 show where the permanent power supply is being fed. In FIG. 7B the circuit flow can be illustrated furthering the simulation of the rendered schematic. In FIG. 7C the final state of the simulation is complete. Note the fuse and engine control relay have been switched.

In this embodiment of the invention, diagnosing of problem areas can be done not only for physical connections, but now current flow can be monitored to determine where other problems can occur, which can be very helpful in performing diagnostic tests.

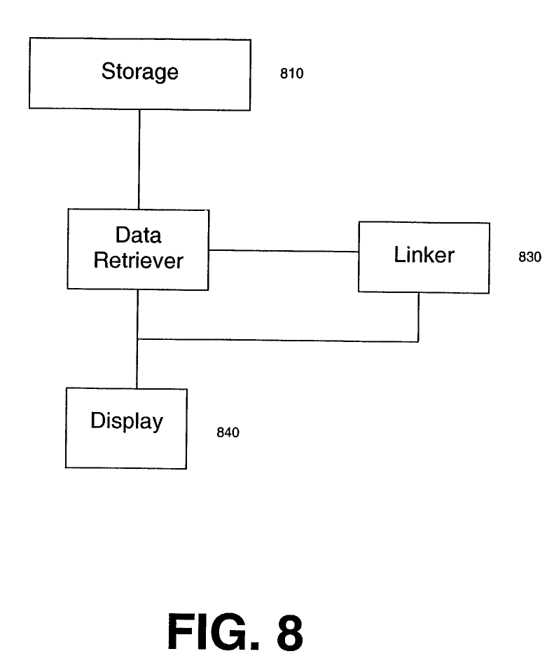

FIG. 8 is an illustration of the device in accordance with another embodiment of the invention. The device includes a storage device 810, a data retriever 820, a linker 830 and a display 840. In this embodiment of the invention data retriever 820 pulls data from storage 810. Thus, when a user is prompted to select an object, the data retriever 810 pulls that object from storage 810. Also being extracted from storage 810 is related date which is related to the object being selected. This is all displayed on display 840 in this embodiment of the invention. Thus, the selected object(s) and all related object(s) can be displayed on a screen along with a graphical representation of each of the object(s). In this embodiment of the invention, one system can hold the data for multiple platforms and engines.

The user will then be prompted to chose a related object to the object that was selected. The display will display all the related objects which can be chosen. Once the user has selected the object or objects that are related to the selected object, the linker 830 will link these two pieces, the related and selected object, together. This can be displayed on display 840 both as a list or in a graphical form or both or any other alternate type of display. The process will continue by providing the user with another set of options in which related objects which could be added onto the schematic which is being rendered is shown. This process continues until the entire schematic is finished. Once the entire schematic is finished the schematic can be saved and referenced for further use.

In one embodiment of the invention, the schematic may be used as a diagnostic test to determine what may be wrong with the specific component. For example, if there was a problem with a tail light blinker, a user could bring up the schematic for the tail light. Since the schematic would show everything that is connected to the tail light it could be easy to diagnose the problem by checking all different connections to the tail light. In another embodiment of the invention, the schematic could be simulated to show how electricity is flowing and to determine where any problem points may be, which is also useful in diagnosing a problem.

Also, instead of having to have several bulky manuals, a single system can be used that incorporates the data of many manuals. It will also be very easy to look-up a component for any item included in a platform because only a single system needs to be accessed. If manuals are used, each of the manual would have to be checked to find the item of interest, which could be very tedious and time consuming.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. A method for creating a layout comprising the steps of:
retrieving selected object data;
displaying related object data associated with said selected object data; and
linking selected related object data to said selected object data to create a layout.

2. The method as recited in claim 1 wherein the step of retrieving selected object data comprises the step of retrieving actual object data and object data that is related to said actual object data.

3. The method as recited in claim 1 further comprising the step of displaying a plurality of object data.

4. The method as recited in claim 3 further comprising the step of providing a way to select from said plurality of object data.

5. The method as recited in claim 1 further comprising the step of displaying said selected object data.

6. The method as recited in claim 1 further comprising the step of providing a way to select said selected related object data.

7. The method as recited in claim 1 further comprising the step of displaying said selected related object data and said selected object data linked to one another.

8. A device for creating a layout comprising:
a reader that retrieves selected object data;
a display in communication with said reader, said display displaying related object data associated with said selected object data; and
a linker that links selected related object data to said selected object data to create a layout.

9. The device as recited in claim 8 wherein said reader reads actual object data and object data that is related to said actual object data.

10. The device as recited in claim 8 wherein said display displays a plurality of object data.

11. The device as recited in claim 10 further comprising a selector in communication with said display, said selector providing a way to select from said plurality of object data.

12. The device as recited in claim 8 wherein said display displays said selected object data.

13. The device as recited in claim 8 further comprising a selector in communication with said display, said selector providing a way to select said selected related object data.

14. The device as recited in claim 8 wherein said display displays said selected related object data and said selected object data linked to one another.

15. A system for creating a layout comprising:
a means for retrieving selected object data;
a means for displaying related object data associated with said selected object data;
a means for linking selected related object data to said selected object data to create a layout.

16. The method as recited in claim 15 wherein said means for retrieving selected object data comprises a means for retrieving actual object data and object data that is related to said actual object data.

17. The system as recited in claim 15 further comprising a means for displaying a plurality of object data.

18. The system as recited in claim 17 further comprising a means for selecting from said plurality of object data.

19. The system as recited in claim 15 further comprising a means for displaying said selected object data.

20. The system as recited in claim 15 further comprising a means for selecting said selected related object data.

21. The system as recited in claim 15 further comprising a means for displaying said selected related object data and said selected object data linked to one another.
